(19) United States
(12) Patent Application Publication
(10) Pub. No.: US 2013/0082044 A1
(43) Pub. Date: Apr. 4, 2013

(54) Portable Appliance for Heating and Cooling Food

(71) Applicant: Jimmy Quang Viet Doan, St. Joseph, MI (US)

(72) Inventor: Jimmy Quang Viet Doan, St. Joseph, MI (US)

(21) Appl. No.: 13/513,228

(22) PCT Filed: Dec. 2, 2010
(86) PCT No.: PCT/US10/58758

§ 371 Date: Nov. 7, 2012

Related U.S. Application Data
(60) Provisional application No. 61/266,089, filed on Dec. 2, 2009.

(51) Int. Cl. A47J 44/00

(52) U.S. Cl. CPC A47J 44/00
USPC 219/387

(57) ABSTRACT

This invention relates to a portable appliance for heating and cooling food comprising an insulated container having an interior wall and exterior wall, the container having an opening for placing food inside said container, electronics capable of heating food inside the container, and a user interface for controlling the electronics. When food is placed inside the container it can be kept cool or alternatively heated to a desired temperature. This invention is portable in nature for easy transport by users. The invention can be used in a vertical or horizontal position.

### FIELD OF INVENTION

The invention relates to a device that serves as both a microwave and a cooler. More specifically, this invention relates to a portable appliance that easily transports food with the option of keeping food chilled and then later heating the food for a meal.

### BACKGROUND ART

There are many times when a person desires to pack food to eat at a later time, for instance a construction worker who brings food to a jobsite or a family taking a daytrip to a park. Many times there may be no access to a refrigerator or microwave oven and therefore the options for food become limited. Refrigerators keep perishable food from spoiling and chill the food meant to be enjoyed cold. Microwave ovens provide a convenient and fast way to heat food up. Coolers and other insulated lunch bags are widely used by the general public. These containers provide a portable way for a user to keep food chilled and fresh for hours until that food is eaten. A drawback is that there is that there is no convenient way to heat food up.

A partial solution to this problem is the development of a portable microwave. There are examples of this, such as those seen in U.S. Pat. Nos. 6,693,267; 6,759,636; and 6,011,909. The problem with these devices is that a user also has to utilize a separate cooler or other method for keeping food fresh until it is time to be heated.

This invention provides for a portable appliance that allows for food to be easily transported while keeping it cool or heated when an external cooling or warming device is not readily available.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF INVENTION

This invention relates to a portable appliance for heating and cooling food comprising:
an insulated container having an interior wall and exterior wall, said container having an opening for placing food inside said container;
electronics capable of heating food inside said container;
and a user interface for controlling said electronics

wherein said portable appliance is functional in the horizontal or vertical position.

The electronics comprise heating technology to warm food items placed in the chamber. One skilled in the art will recognize that microwave technology is a preferred method of heating but other methods are also suitable. Such methods include conductive, convection, thermoelectric, heat exchangers, or other similar technologies.

Microwave ovens are well known in prior art and use a combination of electrical circuits and mechanical devices to produce and control the output of microwave energy for heating and cooking. The major high-voltage electronic components of conventional microwave ovens, and the electronics of this invention, consist of a transformer, capacitor and magnetron tube. The magnetron tube converts electricity from the power source into microwaves which are transmitted into the cavity of the oven and into the food. Microwaves enter the food and excite the molecules to generate heat evenly throughout food. Microwaves reflect off the cavity walls and metal door screen to reach all surfaces of the food from every direction.

A user interfaces allows a person to set the desired cooking performance. Control electronics, such as timers and relays, in turn, determine the performance of the high-voltage components. State of the art microwave ovens can use inverter technology. Inverter microwave ovens use inverter circuit boards to replace the transformer and capacitor of conventional microwave ovens making them more efficient.

The chamber of the insulated container is accessible through a door at the top of the container. This door may be completely removable or may simply open while remaining affixed to the container. For purposes of describing this invention, it will be discussed as the door opening on a hinge affixed to the container. The door must open far enough to allow the placement of food within the container. While 90 degrees would be an acceptable angle for opening, it is anticipated that a smaller or larger angle of opening would be suitable.

When a user wishes to heat food stored in the insulated container, he/she activates the user interface which will in turn activate the electronics controlling the heating technology used. This user interface allows the user to program the heating technology including time and power settings. One skilled in the art will recognize that there a large number or time settings that can be implemented such as a key pad for programming a desired time or a one touch button with a pre-set time allotment. It is anticipated that a display screen will indicate the amount of time a user has programmed.

The electronics are powered by a power source. Such sources may include electricity, batteries, or natural gas. The insulated container comprises a power source input on the outside of the exterior wall. This power source input may be limited to one type of power source or may be convertible to multiple power sources.

The electronics may be housed in a variety of locations within the portable appliance. The location of such electronics varies on the size and design of the portable appliance. In some designs of the portable appliance the electronics will be housed in the base. In other designs, the electronics will be housed in the door of the portable appliance. One skilled in the art will recognize that the location of the electronics does not have an impact on the performance of the portable appliance.

The insulated container comprises insulation located between the interior wall and exterior wall. Many insulation methods are preferred such as air, gas, foam, aerogel, and gel. One skilled in the art will recognize that this list is not limiting in insulation materials that can be used. While the preferred embodiment of this invention relies on insulation to keep items cool, it is also anticipated that refrigeration is also possible. The electronics of this invention can also be used to cool items.

It is imperative to this invention that the insulated container be portable and lightweight. Therefore, it is anticipated that the container comprise handles, straps, wheels, or other methods for easily transporting the container. It is anticipated that a number of arrangements would be suitable for positioning the handles, straps, or wheels. However, for purposes of describing this invention, any strap or handle will be preferably affixed to the sides of the portable appliance.

The portable appliance for heating and cooling food may also comprise other amenities including but not limited to a cup holder. Another amenity would be a removable container. This removable container can be placed on the interior of the portable device and can be used to hold ice for cooling or can be used as a separate container for heating. Still another amenity would include racks, dividers, or other partitions. These racks, dividers, or partitions would be used to store items neatly within the portable appliance. One skilled in the art will recognize that these amenities may be built into the portable container or may be modular in nature.

This portable appliance is not limited in shape or size. Sizes can vary from a small, single user appliance to a larger capacity appliance used to hold a larger quantity of food. For purposes of describing this invention a generally rectangular appliance is used, but this shape is not to be construed as limiting in any way as other shapes are contemplated.

This invention may be operated in either the horizontal or vertical position. It is not imperative that one particular side (i.e. the side with the user interface) always be orientated in a set position. A user can operate this invention, regardless of the design, in the horizontal position (user interface facing the user) or in the vertical position (user interface facing upwards). The positioning of the portable device does not impact the functionality of the invention and allows a user flexibility in the arrangement of operation.

### BRIEF DESCRIPTION OF THE DRAWINGS

Possible and preferred features of the present invention will now be described with particular reference to the accompanying drawings. However, it is to be understood that the features illustrated in and described with reference to the drawings are not to be construed as limiting on the broad scope of the invention. In the drawings:

FIG. 1 is a perspective view of the portable appliance for heating and cooling food in the vertical position and in a larger appliance size that could be considered appropriate for multiple users;

FIG. 2 depicts the portable appliance for heating and cooling food in the larger appliance size in the horizontal and open position exposing the chamber;

FIG. 3 is a perspective view of the portable appliance for heating and cooling food in the vertical position comprising wheels and an electrical power source and in the open position;

FIG. 4 is a perspective view of the portable appliance for heating and cooling food in a smaller appliance size that could be considered appropriate for a single user;

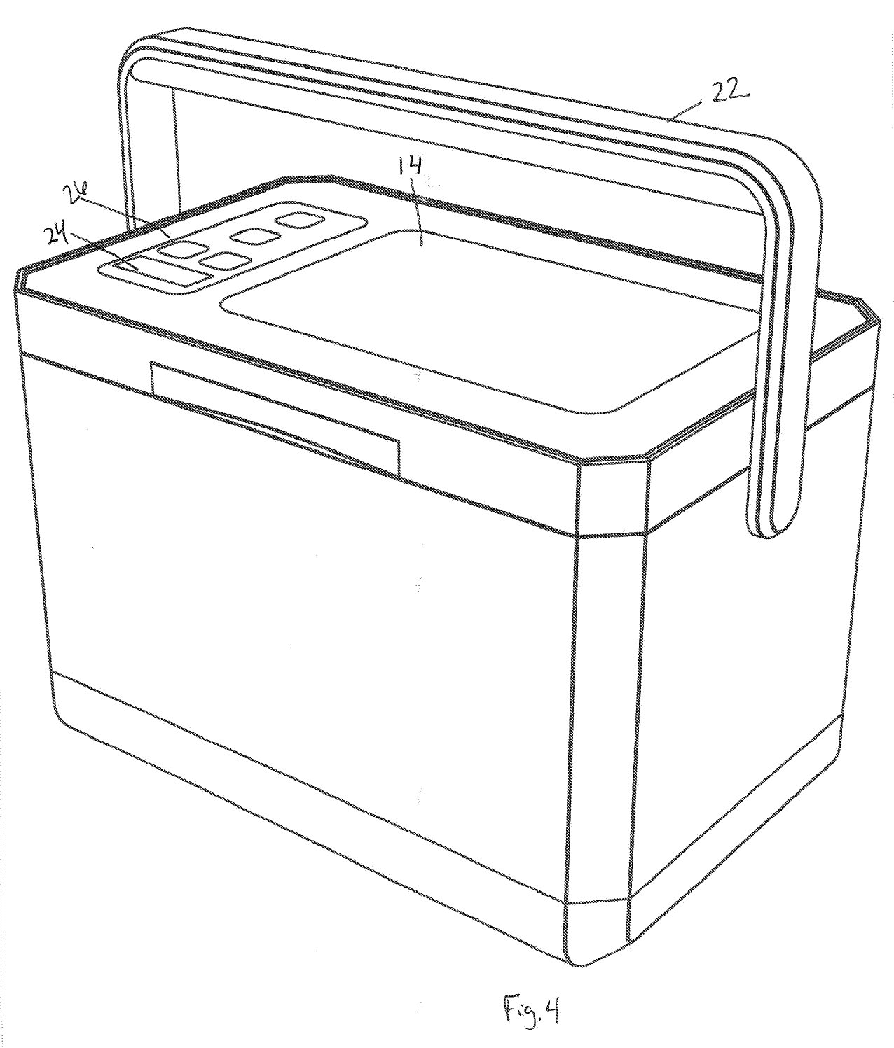

FIG. 5 is a perspective view of the portable appliance for heating and cooling food in the smaller appliance size the open and horizontal position;

FIG. 6 depicts a a perspective view of the portable appliance for heating and cooling food in the smaller appliance size the open and vertical position depicting an alternate variation of the latch;

FIG. 7 is another view of the portable appliance for heating and cooling food showing the power cord in the retracted position;

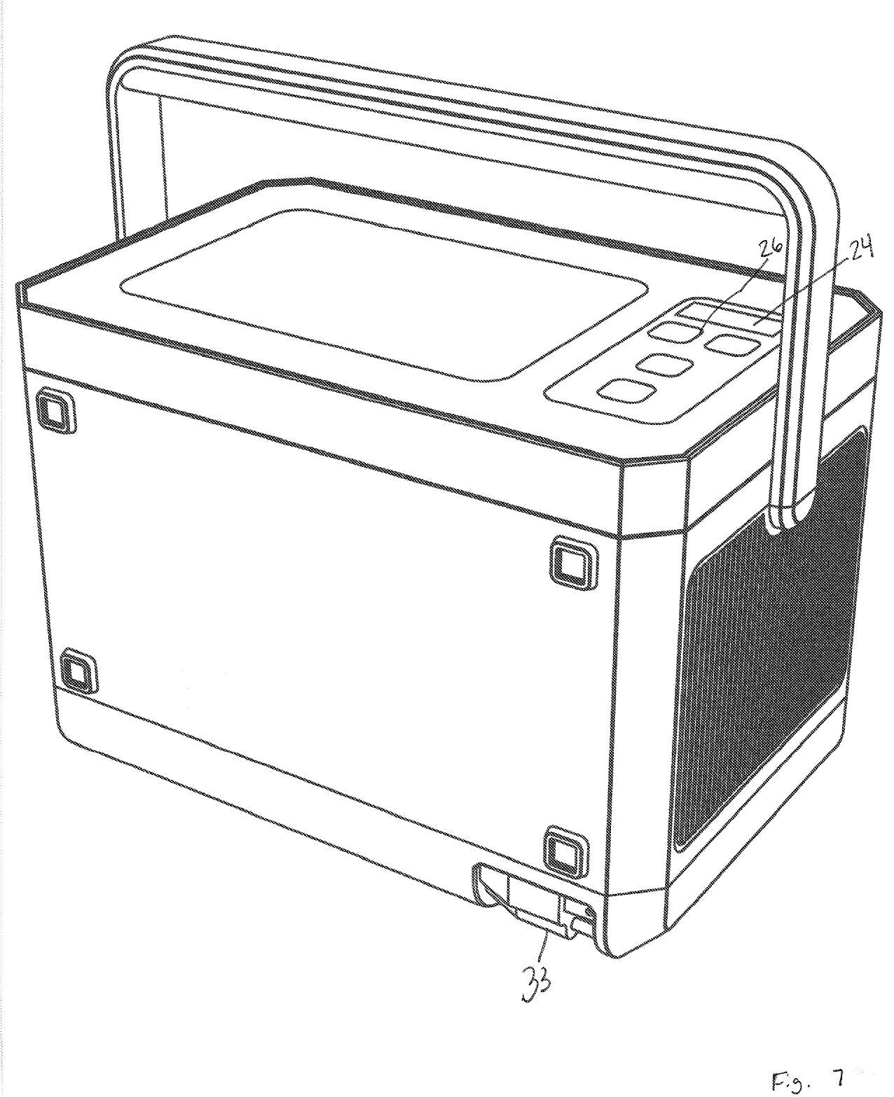

FIG. 8 is a view of the portable appliance detailing a strap; and

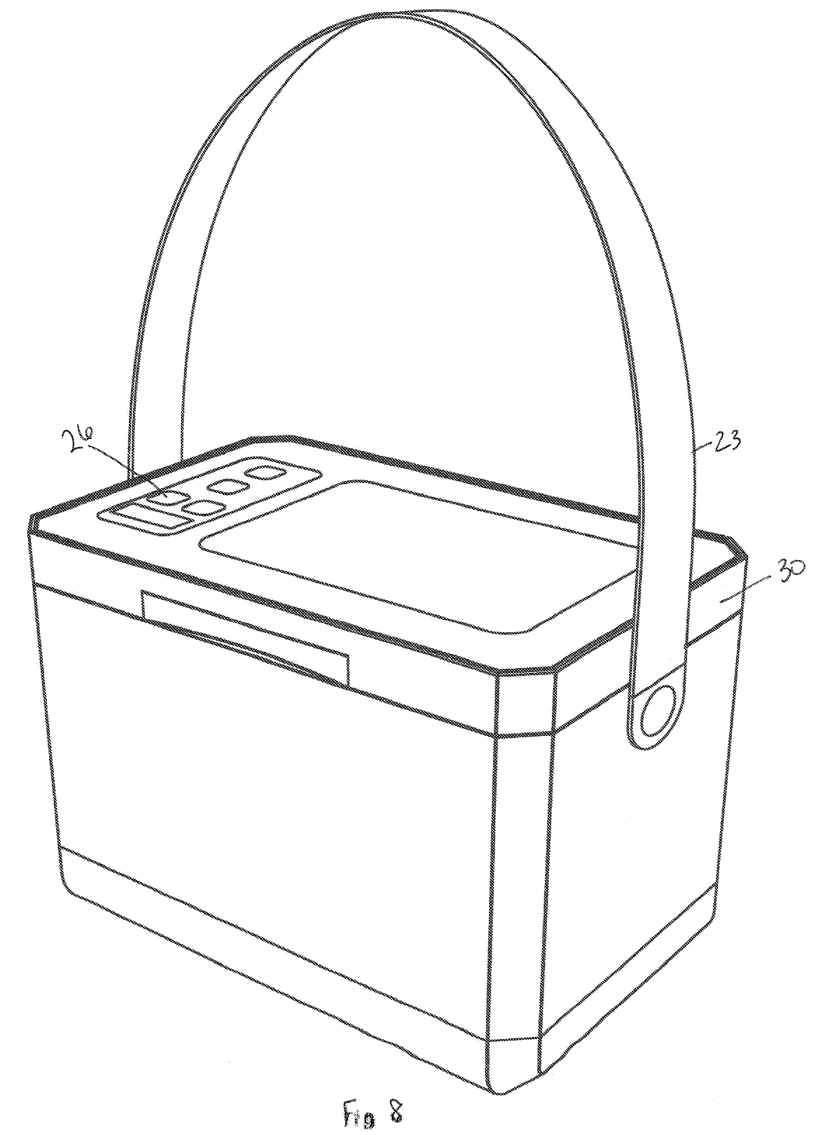

FIG. 9 is a cross-sectional view of the portable appliance for heating and cooling food.

### DETAILED DESCRIPTION OF THE DRAWINGS

This invention relates to a portable appliance 2 for heating and cooling food. This portable appliance 2 for heating and cooing food comprises an insulated container 3 having an interior wall 6 and exterior wall 10, the container 3 has an opening 5 for placing food (not shown) inside said container 3, electronics 8 capable of heating food inside said container 3, and a user interface 26 for controlling said electronics 8.

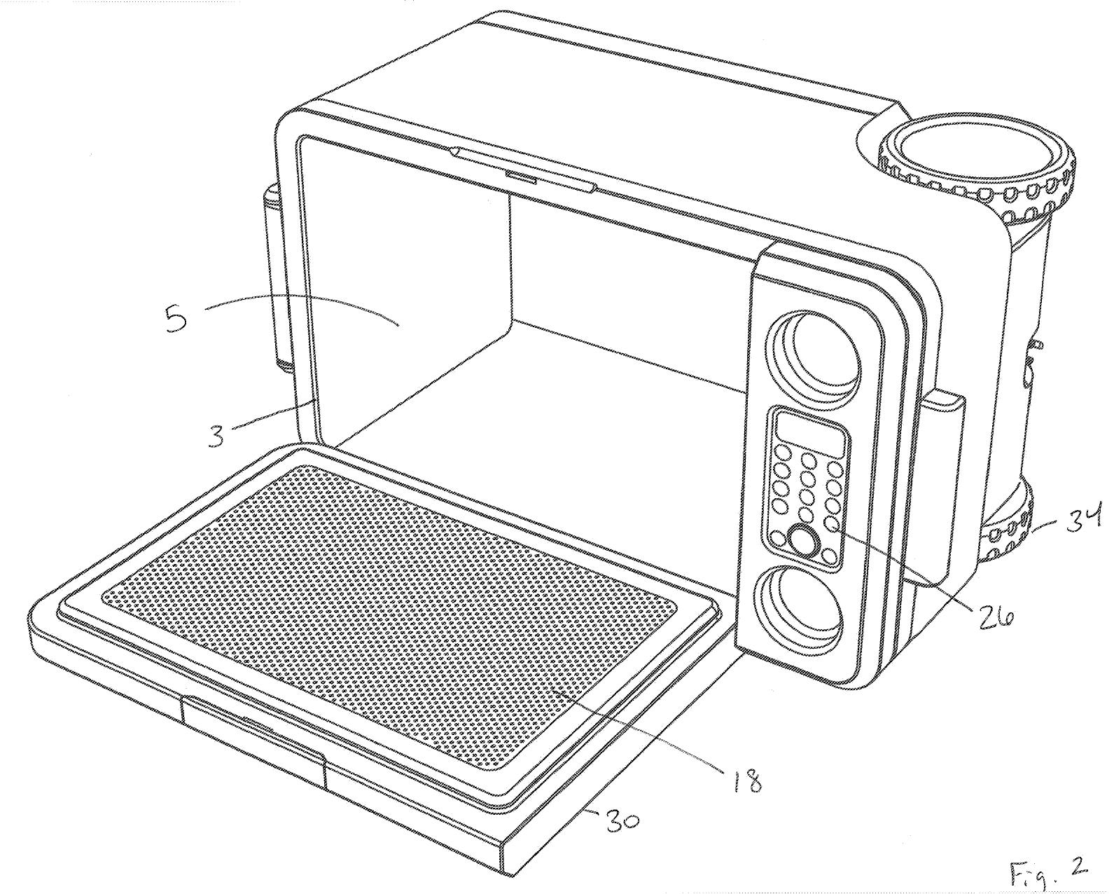

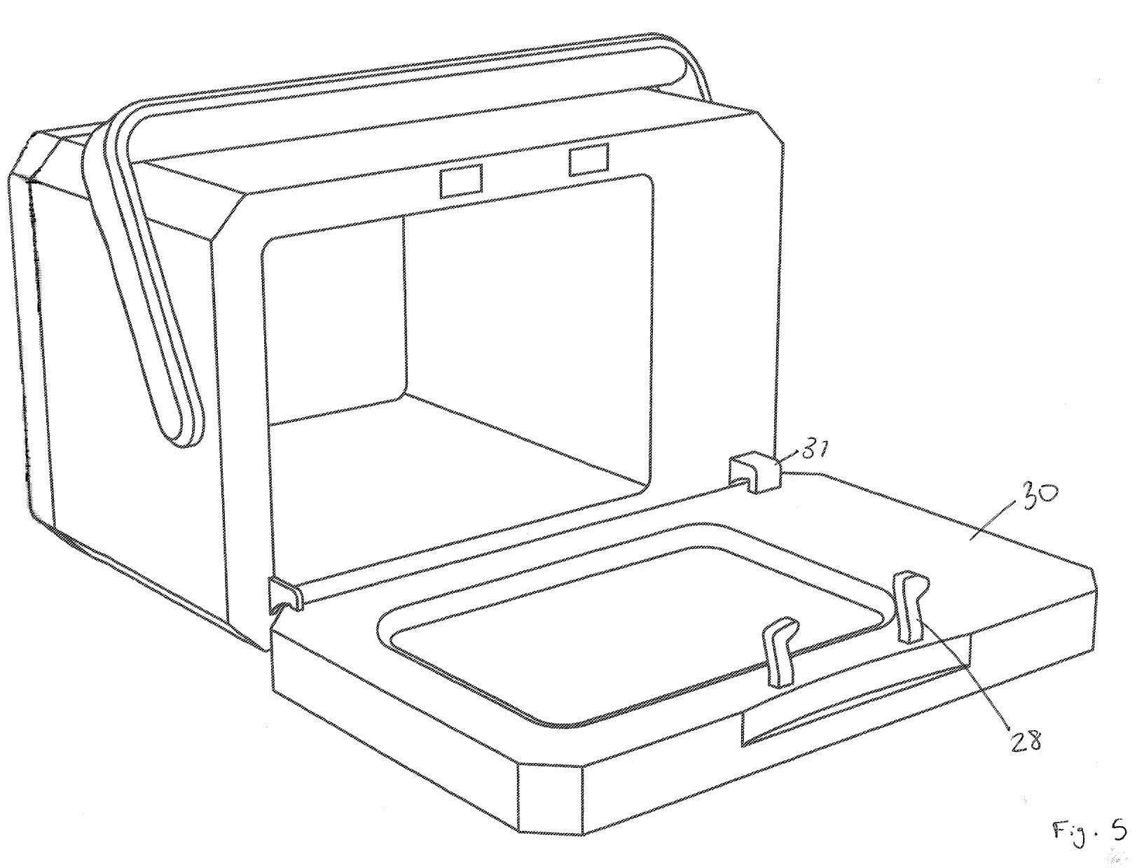

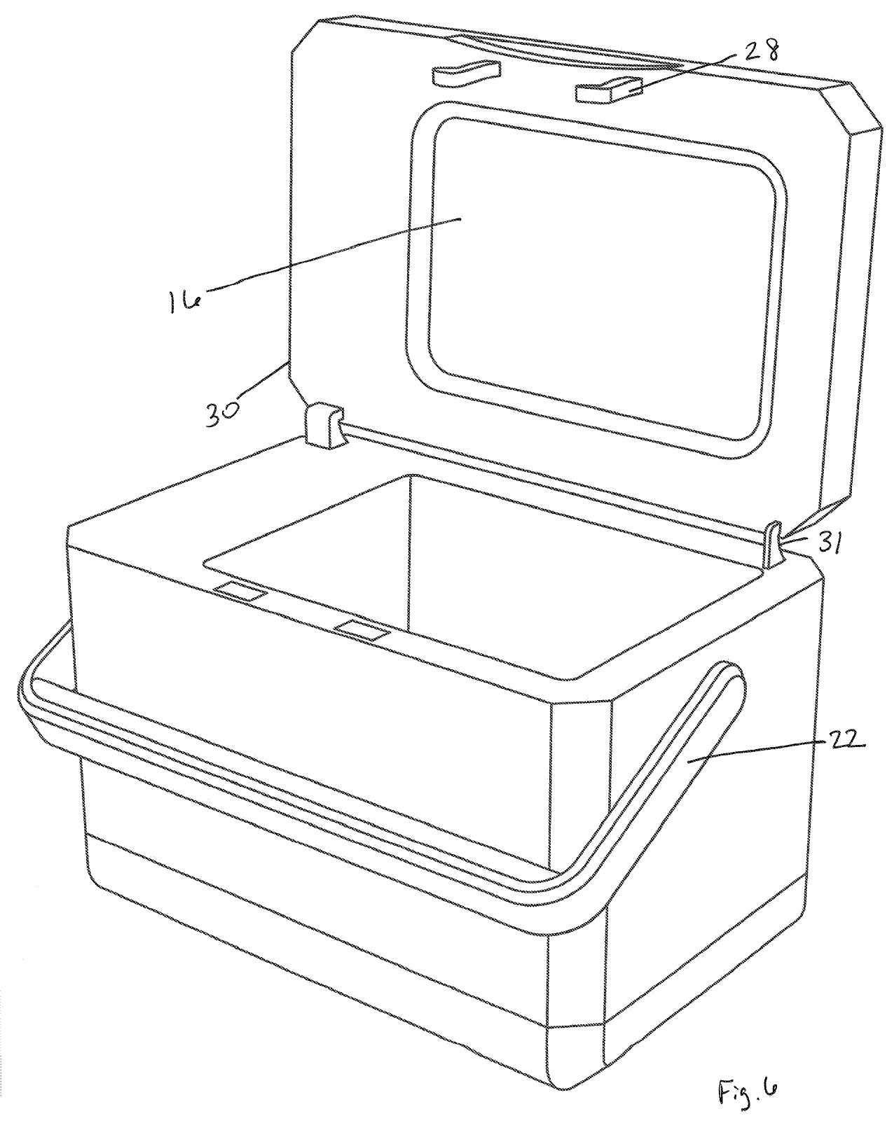

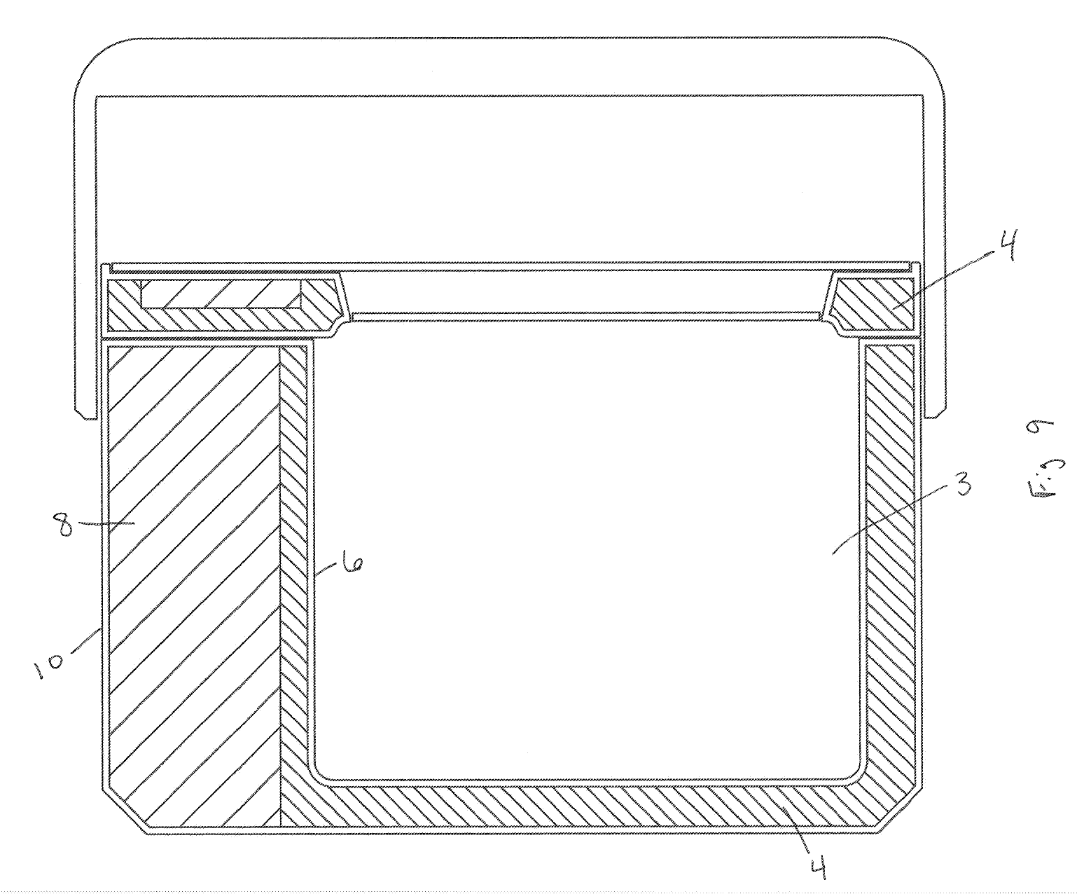

As seen in FIG. 9, the interior wall 6 is separated from the exterior wall 10 by way of insulation 4. This insulation 4 aids in controlling temperature within the chamber 3. The container 3 comprises a door 30 for covering the opening 5 to the chamber. This door 30 affixed to the chamber 3 by way of a hinge 31. This door 30 may also be equipped with a latch 28, such as the one seen in FIGS. 2-3 and 5-6. Certain embodiments of the door, such as the ones seen in the figures, may comprise an inner window 16 and outer window 14. A perforated screen 18 is seen covering the inner window 16 in FIG. 2.

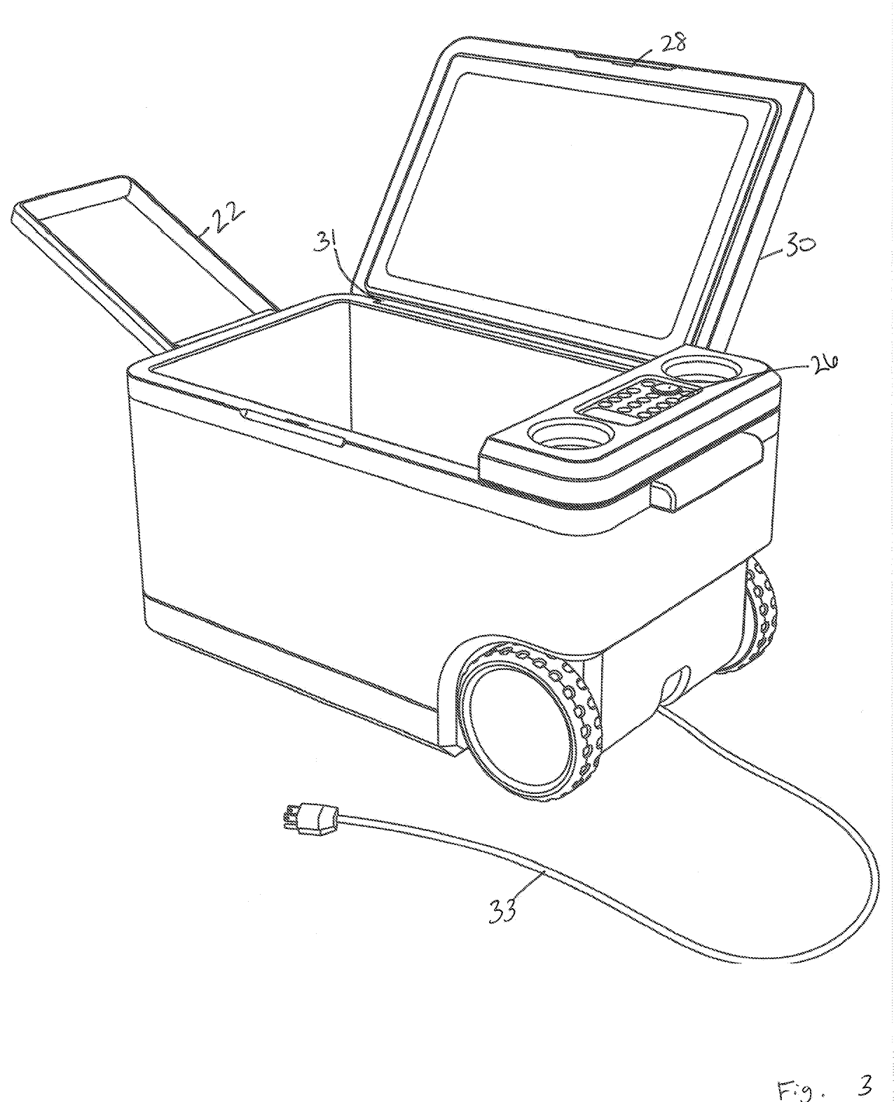

When a user desires to heat food stored within the chamber 3, the electronics 8 must be activated. The electronics 8 are powered by an energy source that is inputted by way of a power cord 33, such as seen in FIG. 3. To activate the electronics 8, a user programs a heat time by using the user interface 26. The time entered will appear on a display screen 24.

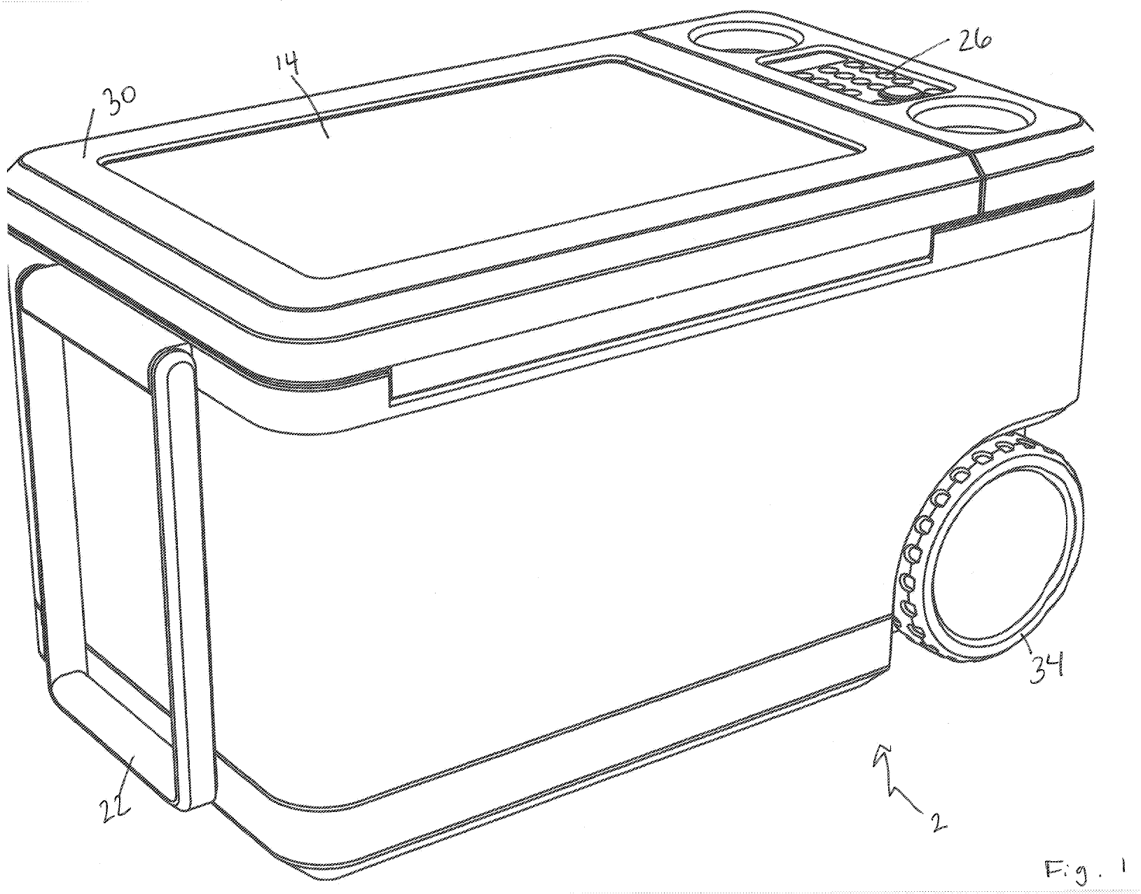

For ease of transport, this insulated container 3 may comprise a handle 22, straps 23 or wheels 34. The handle 22 is preferably situated on the side of the insulated container and in an position that does not interfere with usage of the user interface 26. The handle 22 can be rotated in a variety of positions, including a stowed position such as seen in FIG. 1.

Preferred features of the present invention will now be described with particular reference to the accompanying drawings. However, it is to be understood that the features illustrated in and described with reference to the drawings are not to be construed as limiting on the scope of the invention.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features n specifically listed, unless the contrary is expressly stated or the context requires otherwise.

It will be appreciated by those skilled in the art that many modifications and variations may be made to the methods of the invention described herein without departing from the spirit and scope of the invention.

What is claimed is:

1. A portable appliance for heating and cooling food comprising:
insulated container having an interior wall and exterior wall, said container having an opening for placing food inside said container;
electronics capable of heating food inside said container;
and a user interface for controlling said electronics
wherein said portable appliance is functional in the horizontal or vertical position.

2. The portable appliance for heating and cooling food as in claim 1 wherein said interior wall and said exterior wall are separated by insulation.

3. The portable appliance for heating and cooling food as in claim 1 wherein said opening further comprises an inner window, an outer window, and perforated screen.

4. The portable appliance for heating and cooling food as in claim 1 wherein said user interface allows a user to operate said electronics to program time and power settings.

5. The portable appliance for heating and cooling food as in claim 1 wherein said portable appliance further comprises handles, straps, or wheels for ease of transport.

6. The portable appliance for heating and cooling food as in claim 5 wherein said handle and straps are located on the side of said portable appliance.
